(19) United States
(12) Patent Application Publication
(10) Pub. No.: US 2024/0238880 A1
(43) Pub. Date: Jul. 18, 2024

(54) DRILL BIT

(71) Applicant: MILWAUKEE ELECTRIC TOOL CORPORATION, Brookfield, WI (US)

(72) Inventors: Ryan T. Bumgarner, Milwaukee, WI (US); Travis J. DuMez, Port Washington, WI (US)

(21) Appl. No.: 18/411,152

(22) Filed: Jan. 12, 2024

Related U.S. Application Data
(60) Provisional application No. 63/479,569, filed on Jan. 12, 2023.

(51) Int. Cl. B23B 51/02

(52) U.S. Cl. CPC B23B 51/02; B23B 2251/14

(57) ABSTRACT

A drill bit including a body and a cutting head. The body includes a shank, an end surface, and a body flute. The shank is at a first end of the body. The end surface at the second end of the body opposite the shank. The body flute extends from the second end of the body toward the first end. The body is configured to rotate about an axis extending through the shank and the end surface. The cutting head is attached to the end surface of the body. The cutting head is configured to drill a hole in the workpiece. A ratio of a cross-sectional area of the hole, measured perpendicular to the axis, to a cross-sectional area of the body at the end surface, measured perpendicular to the axis, is greater than 2.

### CROSS-REFERENCE TO RELATED APPLICATION

This application claims priority to U.S. Provisional Patent Application No. 63/479,569, filed on Jan. 12, 2023, the entire contents of which are incorporated herein by reference.

### FIELD OF THE INVENTION

The present invention relates to power tool accessories. More specifically, the present invention relates to drill bits.

### BACKGROUND

Drill bits, such as masonry drill bits, are used to drill holes into hard materials such as concrete, cinder block, stone, brick (e.g., red brick), tile, metal, wood, plastic, porcelain, ceramics and the like. Some drill bits can be used with power tools such as hammer drills and impact drills that are operable in a drilling mode which only rotates the masonry drill, a chisel mode which delivers only percussive force to the masonry drill, or a hammer drill mode which rotationally drives the masonry drill and delivers a percussive force to the masonry drill.

### SUMMARY

In one aspect, the disclosure provides a drill bit including a body and a cutting head. The body includes a shank, an end surface, and a body flute. The shank is at a first end of the body. The end surface at the second end of the body opposite the shank. The body flute extends from the second end of the body toward the first end. The body is configured to rotate about an axis extending through the shank and the end surface. The cutting head is attached to the end surface of the body. The cutting head is configured to drill a hole in the workpiece. A ratio of a cross-sectional area of the hole, measured perpendicular to the axis, to a cross-sectional area of the body at the end surface, measured perpendicular to the axis, is greater than 2.

In one aspect, the disclosure provides a drill bit including a body and a cutting head. The body includes a shank at a first end of the body and an end surface at a second end of the body opposite the shank. The body is configured to rotate about an axis extending through the shank and the end surface. The cutting head includes a unitary body that is formed separately from the body and attached to the end surface of the body. The cutting head is configured to drill a hole in a workpiece. A ratio of a cross-sectional area of the hole, measured perpendicular to the axis, to a cross-sectional area of the unitary body, measured perpendicular to the axis, is greater than 2.

In another aspect, the disclosure provides a method of manufacturing a drill bit. The method includes forming a body of the drill bit with a shank at a first end of the body, an end surface at a second end of the body, and a body flute extending from the second end of the flute toward the first end of the body, forming a cutting head, and attaching the cutting head to the end surface of the body. The body is configured to rotate about an axis of rotation extending through the shank and the end surface. The cutting head is configured to drill a hole in a workpiece. A ratio of a cross-sectional area of the hole, measured perpendicular to the axis, to a cross-sectional area of the body at the end surface, measured perpendicular to the axis, is greater than 2.

Other aspects of the invention will become apparent by consideration of the detailed description and accompanying drawings.

### BRIEF DESCRIPTION OF THE DRAWINGS

FIG. 1 is a plan view of a drilling tool including a cutting head according to an embodiment of the disclosure.

FIG. 2 is an exploded view of the drilling tool and the cutting head of FIG. 1.

FIG. 3 is a top view of a cutting head according to another embodiment of the disclosure.

FIG. 4A is a plan view of the cutting head of FIG. 3.

FIG. 4B is a plan view of an alternative embodiment of the cutting head of FIG. 3.

FIG. 5 is a top view of a cutting head according to another embodiment of the disclosure.

FIG. 6A is a plan view of the cutting head of FIG. 5.

FIG. 6B is a plan view of an alternative embodiment of the cutting head of FIG. 5.

FIG. 7 is a top view of a cutting head according to another embodiment of the disclosure.

FIG. 8A is a plan view of the cutting head of FIG. 7.

FIG. 8B is a plan view of an alternative embodiment of the cutting head of FIG. 7.

FIG. 9 is a top view of a cutting head according to another embodiment of the disclosure.

FIG. 10A is a plan view of the cutting head of FIG. 9.

FIG. 10B is a plan view of an alternative embodiment of the cutting head of FIG. 9.

FIG. 11 is a table including data from a concrete drilling test with cutting heads according to embodiments of the disclosure.

FIG. 12 is a graph depicting the data from the table of FIG. 11.

FIG. 13 is a schematic illustrating a method of manufacturing the drilling tool of FIG. 1 and the cutting head of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

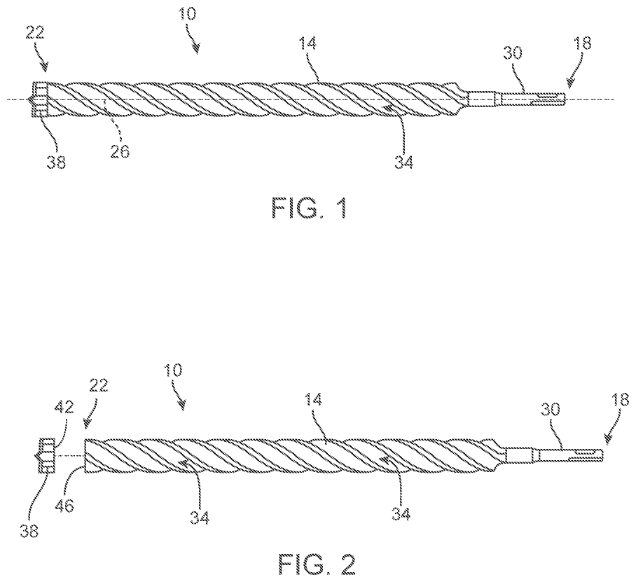

FIG. 1 illustrates a drilling tool. The drilling tool 10 includes a body 14 having a first end 18, a second end 22 opposite the first end 18, and an axis of rotation 26 extending through the first and second ends 18, 22. A shank 30 is positioned adjacent the first end 18. The shank 30 is operable to connect the drilling tool 10 to a power tool such as a drill or rotary hammer. As such, the shank 30 may be configured as an SDS-style shank, such as an SDS shank, an SDS Plus shank, or an SDS Max shank. In other embodiments, the shank 30 may have other configurations, such as a hex shank. The drilling tool 10 also includes a body flute 34 that extends between the first and second ends 18, 22. In the illustrated embodiment, the drilling tool 10 includes four body flutes 34. In other embodiments, the drilling tool 10 may include fewer or more body flutes 34. As such, at least a portion of the body 14 includes the body flutes 34. The drilling tool 10 further includes a cutting head 38 that is positioned at the second end 22 of the drilling tool 10.

In the illustrated embodiment, with reference to FIG. 2, the cutting head 38 is formed as a unitary body. The cutting head 38 may be formed of the same material as the body 14 or may be formed of a different material. For example, in some embodiments, the cutting head 38 may be formed of carbide, and the body 14 may be formed of steel. The cutting head 38 may be attached to the body 14 of the drilling tool 10 through welding, brazing, or a combination of both. For example, the cutting head 38 may be attached to the body 14 through welding with induction heating which may allow for precise and repeatable heating of the cutting head 38 and the body 14 to join the cutting head 38 to the body 14. In other embodiments, the cutting head 38 may be attached to the body 14 through another means, such as diffusion bonding. As such, a bottom surface 42 of the cutting head 38 may abut, or rest directly on, an end surface 46 of the body 14 at the second end 22 of the drilling tool 10 when the cutting head 38 is attached to the body 14. That is, the cutting head 38 is not inserted into slots formed in the body 14, as may be typical of prior art drill bits. In other embodiments, the cutting head 38 may be attached to the body 14 through another attaching means. In the illustrated embodiment, both the bottom surface 42 of the cutting head 38 and the end surface 46 of the body 14 are oriented perpendicularly to the axis of rotation 26.

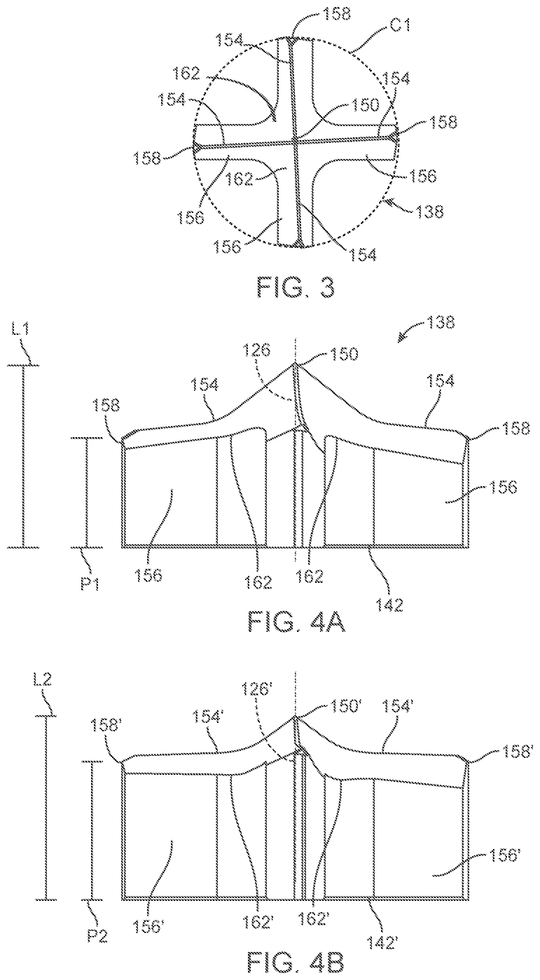

FIGS. 3 and 4A illustrate a cutting head 138 according to an embodiment of the disclosure. The cutting head 138 may be attached to the body 14 of the drilling tool 10 (FIG. 2) through welding, brazing, diffusion bonding, or any combination thereof, as described above, such that the cutting head 138 is configured to rotate about an axis of rotation 126. The axis of rotation 126 and the axis of rotation 26 of FIG. 1 may be collinear when the cutting head 138 is attached to the body 14 of the drill bit 10. The cutting head 138 includes a bottom surface 142 oriented perpendicularly to the axis of rotation 126, a cutting tip 150, and a plurality of cutting edges 154. Specifically, the plurality of cutting edges 154 includes four cutting edges 154. In other embodiments, the plurality of cutting edges 154 may include two cutting edges 154, three cutting edges 154, or more than four cutting edges 154. Each of the cutting edges 154 is formed on a land 156, or wing, of the cutting head 138. Each of the cutting edges 154 extends substantially linearly from the cutting tip 150 to a corresponding peripheral cutting end 158 disposed on an outer periphery of the cutting head 138. The cutting head 138 further includes web portions 162 disposed between adjacent cutting edges 154. Each of the cutting edges 154 are spaced equidistantly from adjacent cutting edges 154 such that a cross-section of the cutting head 138 taken normal, or perpendicularly, to the axis of rotation 126 is substantially cross-shaped and includes the web portions 162. In some embodiments, the cutting edges 154 and/or the lands 156 may be unequally spaced apart from each other, yet the cutting head 138 may still be generally cross-shaped. In the illustrated embodiment of FIG. 3, the cutting head 138 has a cross-sectional area of about 254 mm². In other embodiments, the cutting head 138 may have a cross-sectional area that is less than 254 mm².

With reference to FIG. 4A, the cutting head 138 has a tip length L1 and a peripheral length P1. The tip length L1 is defined as a height of the cutting head 138 at the tip 150 and is measured between the bottom surface 142 of the cutting head 138 and the cutting tip 150. The peripheral length P1 is defined as a height of the lands 156, and is measured between the bottom surface 142 of the cutting head 138 and one of the cutting edges 154 at the corresponding peripheral cutting end 158. The tip length L1 and the peripheral length P1 extend parallel to the axis of rotation 126. The peripheral length P1 is shorter than the tip length L1. In other words, the peripheral length P1 is a percentage, or a fraction, of the tip length L1. In the illustrated embodiment, the peripheral length P1 may be between one-half and three-fourths the size of the tip length L1. Stated another way, the peripheral length P1 may be at most three-fourths and at least one-half the size of the tip length L1. In some embodiments, the peripheral length P1 may be at most two-thirds the size of the tip length L1. As such, each of the cutting edges 154 slope at least partially toward the bottom surface 142 of the cutting head 138 as the cutting edges 154 extend toward the peripheral cutting ends 158. In some embodiments, the cutting edges 154 may not be sloped. Specifically, the cutting edges 154 may extend perpendicular to the axis of rotation 126 such that the tip length L1 and the peripheral length P1 are equivalent.

In an alternative embodiment of the cutting head 138′, the cutting head 138′ may have a different tip length and a different peripheral length. FIG. 4B illustrates the cutting head 138′ with another tip length L2 and another peripheral length P2 which extend parallel to an axis of rotation 126′. The cutting head 138′ includes a bottom surface 142′, a cutting tip 150′, a plurality of cutting edges 154′ formed on a plurality of lands 156′, peripheral cutting ends 158′, and web portions 162′. The tip length L2 of the cutting head 138′ of FIG. 4B is equivalent to the tip length L1 of the cutting head 138 of FIG. 4A. In some embodiments, the tip lengths L1, L2 may be different. The peripheral length P2 of the cutting head 138′ of FIG. 4B is taller, or longer, than the peripheral length P1 of the cutting head 138 of FIG. 4A. As such, the peripheral length P2 is a larger percentage, or a larger fraction, of the tip length L2 for the cutting head 138′ of FIG. 4B than the peripheral length P1 and the tip length L1 of the cutting head 138 of FIG. 4A. Each of the cutting edges 154′ slopes a lesser amount toward the bottom surface 142′ of the cutting head 138′ of FIG. 4B than the cutting edges 154 for the cutting head 138 of FIG. 4A. As such, the cutting edges 154′ of FIG. 4A are steeper than the cutting edges 154 of FIG. 4B.

In embodiments with the cutting head 138 of FIG. 4A or the cutting head 138′ of FIG. 4B, at least a portion of the body (such as the body 14) of the drill bit (such as the drill bit 10) may be formed with a cross-sectional area between 228 mm² and 254 mm². Specifically, the portion of the body of the drill bit including the body flutes (such as the body flutes 34) may be formed with a cross-sectional area between 228 mm² and 254 mm². As such, the body of the drill bit at the end surface (such as the end surface 46) may have a similar cross-sectional area as the cutting head 138 of FIG. 4A or the cutting head 138′ of FIG. 4B. Alternatively, the body of the drill bit at the end surface may have a slightly smaller cross-sectional area then the cutting head 138 of FIG. 4A or the cutting head 138′ of FIG. 4B.

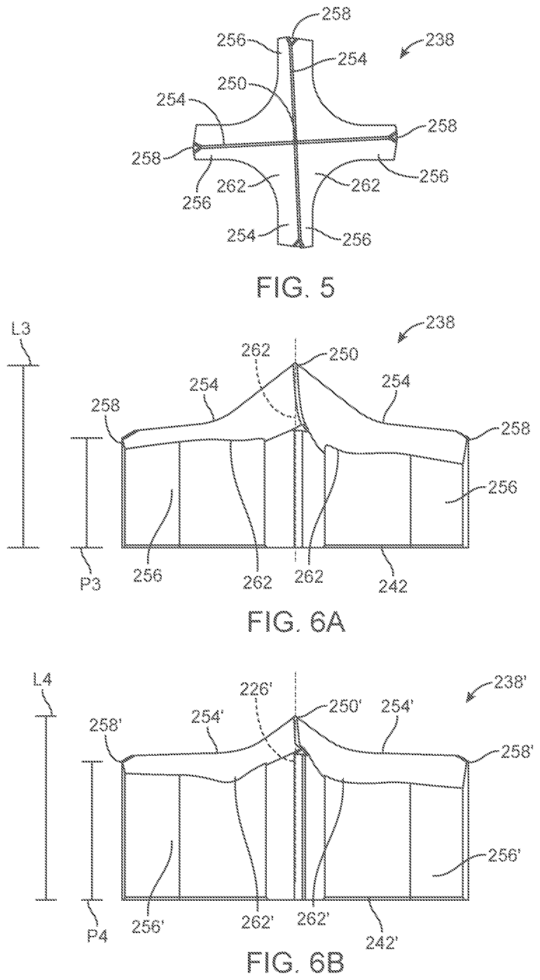

FIG. 5 illustrates another embodiment of a cutting head 238. The cutting head 238 is substantially similar to the cutting head 138 of FIG. 3, except for the differences described below. The cutting head 238 may be attached to the body 14 of the drilling tool 10 (FIG. 2) through welding, brazing, diffusion bonding, or any combination thereof, as described above, such that the cutting head 238 is configured to rotate about an axis of rotation 226. The cutting head 238 includes a bottom surface 242, a cutting tip 250, a plurality of cutting edges 254 formed on a plurality of lands 256 or wings, peripheral cutting ends 258, and web portions 262. The web portions 262 extend further outwardly from the cutting tip 250 than the distance the web portions 162 extend from the cutting tip 150 of FIG. 3. As such, the web portions 262 are greater in cross-sectional area than the web portions 162 of FIG. 3, and therefore, the cutting head 238 has a greater cross-sectional area than the cutting head 138 of FIG. 3. In the illustrated embodiment of FIG. 5, the cutting head 238 has a cross-sectional area of about 290 mm². In other embodiments, the cutting head 238 may have a cross-sectional area between 254 and 290 mm².

With reference to FIG. 6A, the cutting head 238 may have a first tip length L3 and a first peripheral length P3. Alternatively, with reference to FIG. 6B, the cutting head 238′ may have a second tip length L4 and a second peripheral length P4. The cutting head 238′ is configured to rotate about an axis of rotation 226′ and includes a bottom surface 242′, a cutting tip 250′, a plurality of cutting edges 254′ formed on a plurality of lands 256′, peripheral cutting ends 258′, and web portions 262′. With reference to FIGS. 6A and 6B, the first tip length L3 and the second tip length L4 are equivalent. In some embodiments, the first tip length L3 and the second tip length L4 may be different. The second peripheral length P4 is taller, or longer, than the first peripheral length P3. As such, the second peripheral length P4 is a larger percentage, or a larger fraction, of the second tip length L4 than the percentage, or fraction, of the first peripheral length P3 relative to the first tip length L3. The cutting edges 254′ for the cutting head 238′ with the relatively longer second peripheral length P4 slope a lesser amount toward the bottom surface 242′ of the cutting head 238′ than the cutting edges 254 of the cutting head 238 with the relatively shorter first peripheral length P3. As such, the cutting edges 254′ of FIG. 6A, are relatively steeper than the cutting edges 254 of FIG. 6B.

In embodiments with the cutting head 238 of FIG. 6A or the cutting head 238′ of FIG. 6B, at least a portion of the body (such as the body 14) of the drill bit (such as the drill bit 10) may be formed with a cross-sectional area between 228 mm² and 290 mm². Specifically, the portion of the body of the drill bit including the body flutes (such as the body flutes 34) may be formed with a cross-sectional area between 228 mm² and 290 mm². As such, the body of the drill bit at the end surface (such as the end surface 46) may have a similar cross-sectional area as the cutting head 238 of FIG. 6A or the cutting head 238′ of FIG. 6B. Alternatively, the body of the drill bit at the end surface may have a smaller cross-sectional area then the cutting head 238 of FIG. 6A or the cutting head 238′ of FIG. 6B.

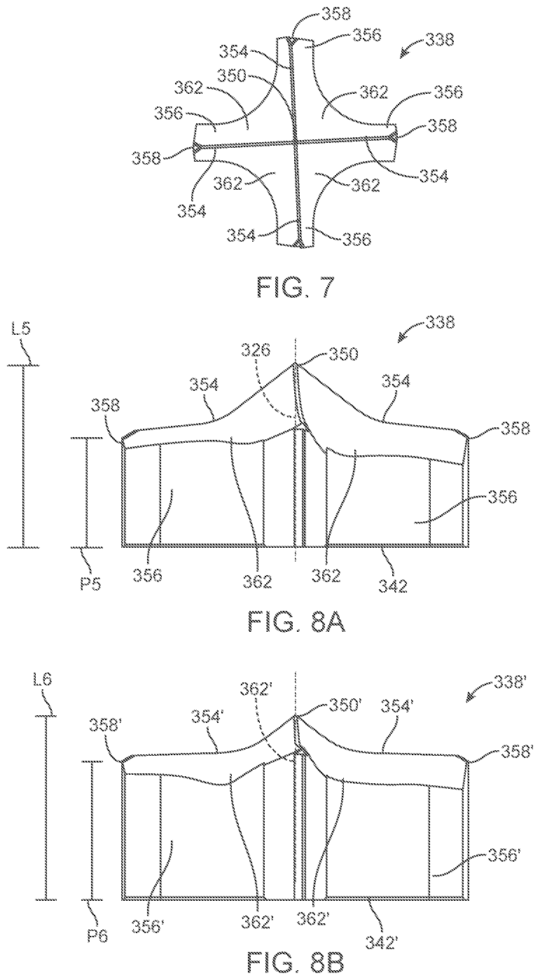

FIG. 7 illustrates another embodiment of a cutting head 338. The cutting head is substantially similar to the cutting head 138 of FIG. 3, except for the differences described below. The cutting head 338 may be attached to the body 14 of the drilling tool 10 (FIG. 2) through welding, brazing, diffusion bonding, or any combination thereof, as described above, such that the cutting head 338 is configured to rotate about an axis of rotation 326. The cutting head 338 includes a bottom surface 342, a cutting tip 350, a plurality of cutting edges 354 formed on a plurality of lands 356 or wings, peripheral cutting ends 358, and web portions 362. The web portions 362 extend further outwardly from the cutting tip 350 than the distance the web portions 262 extend from the cutting tip 250 of FIG. 5 and the distance the web portions 162 extend from the cutting tip 150 of FIG. 3. As such, the web portions 362 are greater in cross-sectional area than the web portions 262 of FIG. 5 and the web portions 162 of FIG. 3, and therefore, the cutting head 338 has a greater cross-sectional area than the cutting head 238 of FIG. 5 and the cutting head 138 of FIG. 3. In the illustrated embodiment of FIG. 7, the cutting head 338 has a cross-sectional area of about 320 mm². In other embodiments, the cutting head 338 may have a cross-sectional area between 290 and 320 mm².

With reference to FIG. 8A, the cutting head 338 may have a first tip length L5 and a first peripheral length P5. Alternatively, with reference to FIG. 8B, the cutting head 338′ may have a second tip length L6 and a second peripheral length P6. The cutting head 338′ is configured to rotate about an axis of rotation 326′ and includes a bottom surface 342′, a cutting tip 350′, a plurality of cutting edges 354′ formed on a plurality of lands 356′, peripheral cutting ends 358′, and web portions 362′. With reference to FIGS. 8A and 8B, the first tip length L5 and the second tip length L6 are equivalent. In some embodiments, the first tip length L5 and the second tip length L6 may be different. The second peripheral length P6 is taller, or longer, than the first peripheral length P5. As such, the second peripheral length P6 is a larger percentage, or a larger fraction, of the second tip length L6 than the percentage, or fraction, of the first peripheral length P5 relative to the first tip length L5. The cutting edges 354′ for the cutting head 338′ with the relatively longer second peripheral length P6 slope a lesser amount toward the bottom surface 342′ of the cutting head 338′ than the cutting edges 354 of the cutting head 338 with the relatively shorter first peripheral length P5. As such, the cutting edges 354′ of FIG. 8A, are relatively steeper than the cutting edges 354 of FIG. 8B.

In embodiments with the cutting head 338 of FIG. 8A or the cutting head 338′ of FIG. 8B, at least a portion of the body (such as the body 14) of the drill bit (such as the drill bit 10) may be formed with a cross-sectional area between 261 mm² and 320 mm². Specifically, the portion of the body of the drill bit including the body flutes (such as the body flutes 34) may be formed with a cross-sectional area between 228 mm² and 254 mm². As such, the body of the drill bit at the end surface (such as the end surface 46) may have a similar cross-sectional area as the cutting head 338 of FIG. 8A or the cutting head 338′ of FIG. 8B. Alternatively, the body of the drill bit at the end surface may have a smaller cross-sectional area than the cutting head 338 of FIG. 8A or the cutting head 338′ of FIG. 8B.

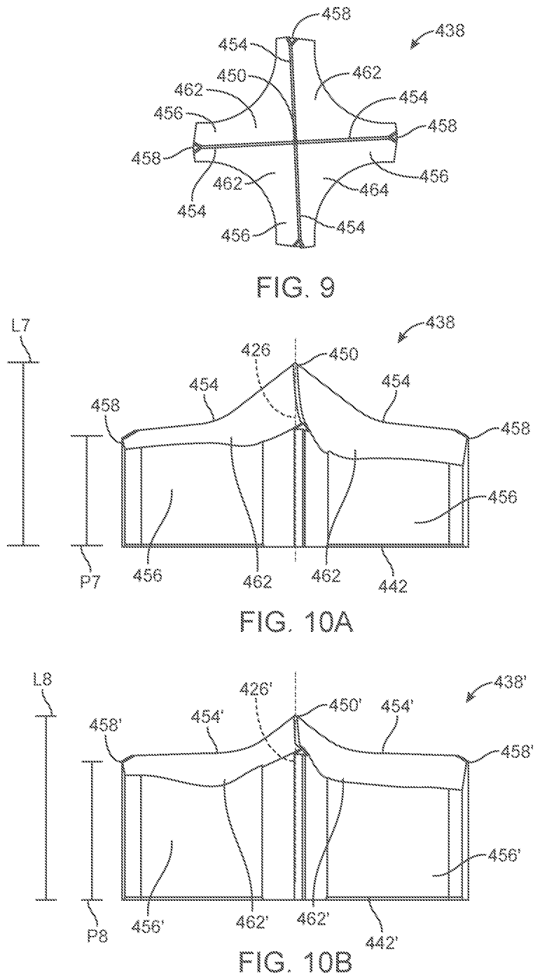

FIG. 9 illustrates another embodiment of a cutting head 438. The cutting head is substantially similar to the cutting head 138 of FIG. 3, except for the differences described below. The cutting head 438 may be attached to the body 14 of the drilling tool 10 (FIG. 2) through welding, brazing, diffusion bonding, or any combination thereof, as described above, such that the cutting head 438 is configured to rotate about an axis of rotation 426. The cutting head 438 includes a bottom surface 442, a cutting tip 450, a plurality of cutting edges 454 formed on a plurality of lands 456 or wings, peripheral cutting ends 458, and web portions 462. The web portions 462 extend further outwardly from the cutting tip 450 than the distance the web portions 362 extend from the cutting tip 350 of FIG. 7, the distance the web portions 262 extend from the cutting tip 250 of FIG. 5, and the distance the web portions 162 extend from the cutting tip 150 of FIG. 3. As such, the web portions 462 are greater in cross-sectional area than the web portions 362 of FIG. 7, the web portions 262 of FIG. 5, and the web portions 162 of FIG. 3, and therefore, the cutting head 438 has a greater cross-sectional area than the cutting head 338 of FIG. 7, the cutting head 238 of FIG. 5, and the cutting head 138 of FIG. 3. In the illustrated embodiment of FIG. 9, the cutting head 438 has a cross-sectional area of about 351 mm². In other embodiments, the cutting head 438 may have a cross-sectional area that is greater than 351 mm².

With reference to FIG. 10A, the cutting head 438′ may have a first tip length L7 and a first peripheral length P7. Alternatively, with reference to FIG. 10B, the cutting head 438′ may have a second tip length L8 and a second peripheral length P8. The cutting head 438′ is configured to rotate about an axis of rotation 426′ and includes a bottom surface 442′, a cutting tip 450′, a plurality of cutting edges 454′ formed on a plurality of lands 456′, peripheral cutting ends 458′, and web portions 462′. With reference to FIGS. 10A and 10B, the first tip length L7 and the second tip length L8 are equivalent. In some embodiments, the first tip length L7 and the second tip length L8 may be different. The second peripheral length P8 is taller, or longer, than the first peripheral length P7. As such, the second peripheral length P8 is a larger percentage, or a larger fraction, of the second tip length L8 than the percentage, or fraction, of the first peripheral length P7 relative to the first tip length L7. As such, the cutting edges 454′ for the cutting head 438′ with the relatively longer second peripheral length P8 slope a lesser amount toward the bottom surface 442′ of the cutting head 438 than the cutting edges 454 of the cutting head 438 with the relatively shorter first peripheral length P7. As such, the cutting edges 454′ of FIG. 10A, are relatively steeper than the cutting edges 454 of FIG. 10B.

In embodiments with the cutting head 438 of FIG. 10A or the cutting head 438′ of FIG. 10B, at least a portion of the body (such as the body 14) of the drill bit (such as the drill bit 10) may be formed with a cross-sectional area that is greater than 415 mm². Specifically, the portion of the body of the drill bit including the body flutes (such as the body flutes 34) may be formed with a cross-sectional area that is greater than 415 mm². As such, the body of the drill bit at the end surface (such as the end surface 46) may have a similar cross-sectional area as the cutting head 438 of FIG. 10A or the cutting head 438′ of FIG. 10B. Alternatively, the body of the drill bit at the end surface may have a smaller cross-sectional area then the cutting head 438 of FIG. 10A or the cutting head 438′ of FIG. 10B.

With reference to FIGS. 1 and 2, adjusting the cross-sectional area, the tip length (as defined above), and the peripheral length (as defined above) of the cutting head 38 may enable a manufacturer to alter performance of the drilling tool 10. That is, the cross-sectional area, the tip length, and the peripheral length may be directly related to the speed with which the drilling tool 10 is able to drill a hole C1 (FIG. 3) into a workpiece. For example, a cutting head 38 having a relatively smaller cross-sectional area may enable faster energy transfer from the shank 30 to the cutting head 38, and thus may enable the drilling tool 10 to drill holes faster. Adjusting the tip length and the peripheral length of the cutting head 38 may also enable the drilling tool 10 to drill holes faster. Additionally, by welding the bottom surface 42 of the cutting head 38 to the end surface 46 of the drilling tool 10, the strength and life of the drilling tool 10 may be increased. As such, welding a cutting head 38 having a relatively low cross-sectional area to the drilling tool 10, as described above, advantageously improves the drill rate (i.e., rate for drilling a hole) without sacrificing life of the drilling tool 10.

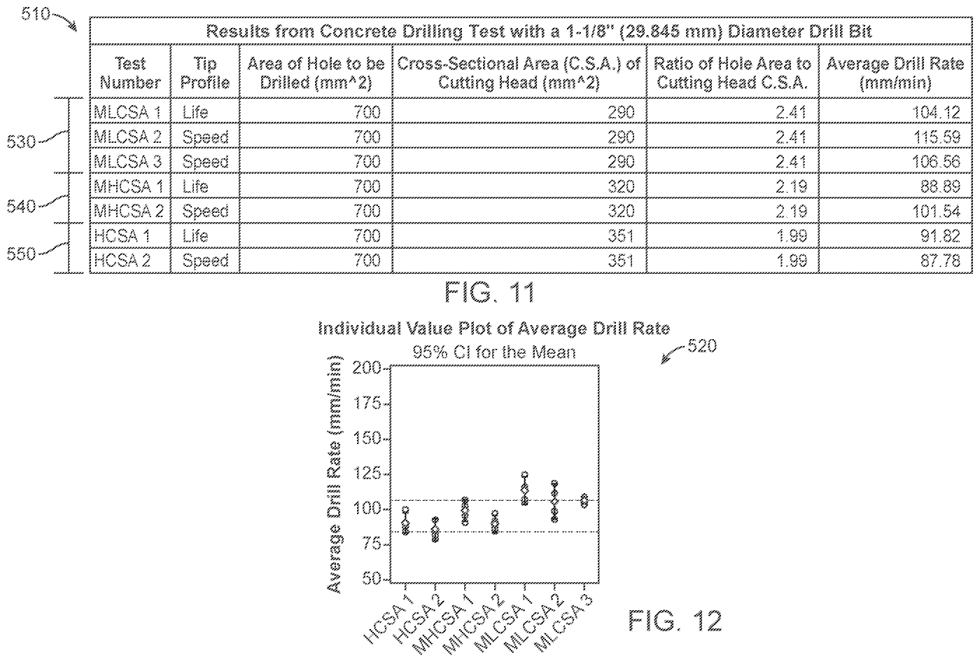

FIG. 11 illustrates a table 510 including data from a concrete drilling test in which the cutting head 238 of FIG. 5, the cutting head 338 of FIG. 7, and the cutting head 438 of FIG. 9 are each, separately, attached to a 1⅛″ (i.e., 1.175″, or 29.845 mm) diameter drilling tool (e.g., the drilling tool 10 of FIG. 1). FIG. 12 illustrates a graph 520 of the data from the table 510 of FIG. 11. With reference to FIGS. 11 and 12, the drilling tool 10 (FIG. 1) having a diameter of 29.845 mm is configured to drill a hole (such as the hole C1 in FIG. 3) having a hole area of roughly 700 mm². In the concrete drilling test, the cutting tips 250 (FIG. 5), 350 (FIG. 7), 450 (FIG. 9) of each of the cutting heads 238 (FIG. 5), 338 (FIG. 7), 438 (FIG. 9) are given either a speed profile or a life profile. That is, the cutting tips 250, 350, 450 may be given chiseling features of varying aggressiveness that provide improved speed or life for the cutting heads 238, 338, 438. Row 530 illustrates performance data for the cutting head 238 of FIG. 5 having a mid-low cross-sectional area (i.e., MLCSA) in which a ratio of the hole area (i.e., 700 mm²) to the cross-sectional area (i.e., 290 mm²) of the cutting head 238 is 2.41. Row 540 illustrates performance data for the cutting head 338 of FIG. 7 having a mid-high cross-sectional area (MHCSA) in which the ratio of the hole area (i.e., 700 mm²) to the cross-sectional area (i.e., 320 mm²) of the cutting head 338 is 2.19. Row 550 illustrates performance data for the cutting head 438 of FIG. 8A with a high cross-sectional area (HCSA) in which the ratio of the hole area (i.e., 700 mm²) to the cross-sectional area (i.e., 351 mm²) of the cutting head 438 is 1.99. Although test data is not shown for the cutting head 138 of FIG. 3, the cutting head 138 has a ratio of the hole area (i.e., 700 mm²) to the cross-sectional area (i.e., 254 mm²) of the cutting head 138 that is equal to 2.76.

Each of the cutting heads 138, 238, 338, 438 described herein is configured to drill a hole (such as the hole C1 in FIG. 3) having a cross-sectional area of at least 285 mm². In some instances, the cutting heads 138, 238, 338, 438 may be configured to drill a hole having a cross-sectional area of 700 mm². Therefore, a ratio of a cross-sectional area of the hole, measured perpendicular to a respective one of the axes of rotation 126, 226, 326, 426, to the cross-sectional area of the cutting heads 138, 238, 338, 438, measured perpendicular to the respective one of the axes of rotation 126, 226, 326, 426, may be greater than 2. In some embodiments, the ratio may be greater than 2.1. In other embodiments, the ratio may be greater than 2.2. In still other embodiments, the ratio may be greater than 2.4. In further embodiments, the ratio may be between 2 and 4. Additionally, a ratio of the cross-sectional area of the hole to the cross-sectional area of a portion the body of the drill bit including the body flutes for each corresponding cutting head 138, 238, 338, 438 may be greater than 2. In some embodiments, the ratio may be greater than 2.1. In other embodiments, the ratio may be greater than 2.2. In still other embodiments, the ratio may be greater than 2.4. In further embodiments, the ratio may be between 2 and 4. The cross-sectional areas are understood to be measured perpendicular to a respective one of the axes of rotation 126, 226, 326, 426.

Although the hole C1 illustrated in FIG. 1 is illustrated as extending through or adjacent to each of the peripheral ends 158 of the cutting head 138, it is understood that the cutting head 138 may have various configurations in which the hole C1 does not extend through or adjacent to each of the peripheral ends 158 of the cutting head 138. For example, with reference to the orientation of the cutting head 138 illustrated in FIG. 1, the vertical lands 156 may have a longer diameter than the horizontal lands 156. In such instances, the diameter of the hole C1 may be greater than the diameter of the horizontal lands.

When given a life profile, the cutting head 238 of FIG. 5 has an average drill rate of 104.12 mm/min. When given a speed profile, the cutting head 238 of FIG. 5 has, in one trial (i.e., MLCSA 2), an average drill rate of 115.59 mm/min and, in another trial (i.e., MLCSA 3), an average drill rate of 106.56 mm/min. When given a life profile, the cutting head 338 of FIG. 7 has an average drill rate of 88.89 mm/min. When given a speed profile, the cutting head 338 of FIG. 7 has an average drill rate of 101.54 mm/min. When given a life profile, the cutting head 438 of FIG. 9 has an average drill rate of 91.82 mm/min. When given a speed profile, the cutting head 438 of FIG. 9 has an average drill rate of 87.78 mm/min. Therefore, when the cross-sectional area of the cutting head 38 (FIG. 1) is decreased, the average drill rate for the drilling tool 10 increases.

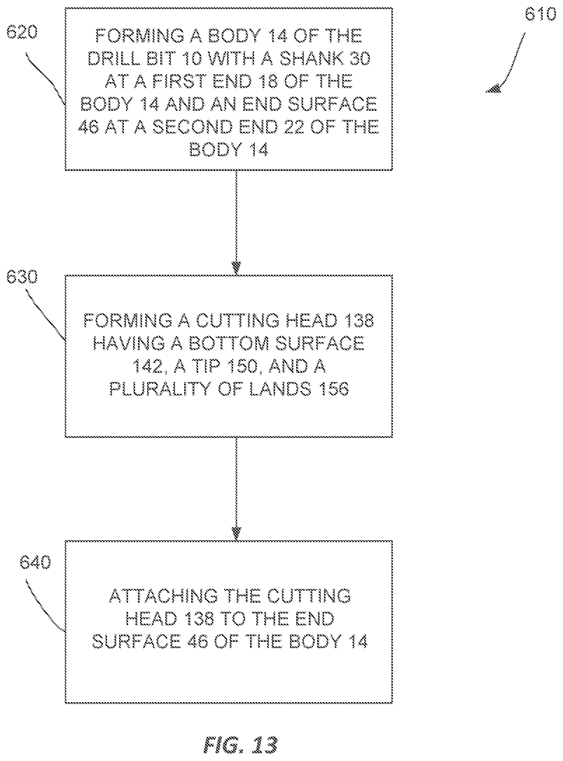

FIG. 13 illustrates a method of manufacturing 610 the drill bit 10 of FIG. 2 with the cutting head 138 of FIG. 4A. Although the method is described with respect to the cutting head 138 of FIG. 4A, it is understood that the description may apply equally to each of the other cutting heads described herein. With reference to FIGS. 2, 3, 4A, and 13, at step 620, the method 610 includes forming the body 14 of the drill bit 10 with the shank 30 at the first end 18 of the body 14 and the end surface 46 at the second end 22 of the body 14. The shank 30 may be formed as an SDS-style shank, a hex shank, or another similar style shank that facilitates connection with a power tool. The end surface 46 is formed perpendicular to the axis 26.

At step 630, the method 610 includes forming the cutting head 138 with the bottom surface 142, the tip 150, and the plurality of lands 156. The bottom surface 142 is formed perpendicular to the axis of rotation 126. The tip 150 is formed opposite from the bottom surface 142. Specifically, the tip 150 is formed having the tip length L1. Each land 156 of the plurality of lands 156 extends from the tip 150 to the corresponding peripheral cutting end 158 such that the cutting head 138 is configured to drill the hole C1. The lands 156 are formed having the peripheral length P1. Forming the plurality of lands 156 includes forming a cutting edge 154 on a corresponding one of the lands 156.

At step 640, the method 610 includes attaching the cutting head 138 to the end surface 46 of the body 14 of the drill bit 10. Specifically, the cutting head 138 may be attached to the end surface 46 of the body 14 through welding, brazing, diffusion bonding, induction heating, furnace heating, and the like. The bottom surface 142 of the cutting head 138 may be directly welded to the end surface 46 of the body 14 such that the cutting head 138 abuts or rests directly on the end surface 46 of the body 14. In other embodiments, the cutting head 138 may be attached to the body 14 through other attachment means.

As described above, some or all illustrated features may be omitted in a particular implementation within the scope of the present disclosure, and some illustrated features may not be required for implementation of all embodiments. The features described above may be implemented in an order different from the order described above and does not prohibit implementation in another order or combination. While not explained in detail for each embodiment and/or construction, the features of the disclosure described herein may be included on a drill bit independent of other features and are not limited to the illustrated disclosure. Embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A drill bit comprising:
a body including
a shank at a first end of the body,
an end surface at the second end of the body opposite the shank, and
a body flute extending from the second end of the body toward the first end, the body configured to rotate about an axis extending through the shank and the end surface; and
a cutting head attached to the end surface of the body, the cutting head configured to drill a hole in a workpiece,
wherein a ratio of a cross-sectional area of the hole, measured perpendicular to the axis, to a cross-sectional area of the body at the end surface, measured perpendicular to the axis, is greater than 2.

2. The drill bit of claim 1, wherein the ratio of the cross-sectional area of the hole to the cross-sectional area of the body at the end surface is greater than 2.1.

3. The drill bit of claim 2, wherein the ratio of the cross-sectional area of the hole to the cross-sectional area of the body at the end surface is greater than 2.4.

4. The drill bit of claim 1, wherein the ratio of the cross-sectional area of the hole to the cross-sectional area of the body at the end surface is between 2 and 4.

5. The drill bit of claim 1, wherein the cutting head includes a bottom surface that is attached to the end surface of the body of the drill bit and is oriented perpendicular to the axis.

6. The drill bit of claim 1, wherein the cutting head includes a unitary body having
a bottom surface,
a cutting tip positioned opposite from the bottom surface and having a tip length measured between the bottom surface and the cutting tip, and
a cutting edge formed on a land, the cutting edge having a peripheral length measured between the bottom surface and the cutting edge at a peripheral cutting end of the land, and
wherein the peripheral length is a fraction of the tip length.

7. The drill bit of claim 1, wherein the cutting head is configured to drill a hole having cross-sectional area greater than 285 mm².

8. A drill bit comprising:
a body including
a shank at a first end of the body, and
an end surface at a second end of the body opposite the shank, the body configured to rotate about an axis extending through the shank and the end surface; and
a cutting head including a unitary body that is formed separately from the body and attached to the end surface of the body, the cutting head configured to drill a hole in a workpiece,
wherein a ratio of a cross-sectional area of the hole, measured perpendicular to the axis, to a cross-sectional area of the unitary body, measured perpendicular to the axis, is greater than 2.

9. The drill bit of claim 8, wherein the ratio of the cross-sectional area of the hole to the cross-sectional area of the unitary body is greater than 2.1.

10. The drill bit of claim 9, wherein the ratio of the cross-sectional area of the hole to the cross-sectional area of the unitary body is greater than 2.4.

11. The drill bit of claim 8, wherein the ratio of the cross-sectional area of the hole to the cross-sectional area of the unitary body is between 2 and 4.

12. The drill bit of claim 8, wherein the cutting head includes a bottom surface that is attached to the end surface of the body of the drill bit and is oriented perpendicular to the axis.

13. The drill bit of claim 8, wherein the cutting head further includes
a bottom surface,
a cutting tip positioned opposite from the bottom surface and having a tip length measured between the bottom surface and the cutting tip, and
a cutting edge formed on a land, the cutting edge having a peripheral length measured between the bottom surface and the cutting edge at a peripheral cutting end of the land, and
wherein the peripheral length is a fraction of the tip length.

14. The drill bit of claim 8, wherein the cutting head is configured to drill a hole having a cross-sectional area greater than 285 mm².

15. A method of manufacturing a drill bit, the method comprising:
forming a body of the drill bit with a shank at a first end of the body, an end surface at a second end of the body opposite the shank, and a body flute extending from the second end of the body toward the first end, the body configured to rotate about an axis extending through the shank and the end surface;
forming a cutting head, the cutting head configured to drill a hole in a workpiece, wherein a ratio of a cross-sectional area of the hole, measured perpendicular to the axis, to a cross-sectional area of the body at the end surface, measured perpendicular to the axis, is greater than 2; and
attaching the cutting head to the end surface of the body.

16. The method of claim 15, wherein the ratio of the cross-sectional area of the hole to the cross-sectional area of the body at the end surface is between 2 and 4.

17. The method of claim 15, wherein attaching the cutting head to the end surface of the body of the drill bit includes welding the cutting head to the end surface of the body of the drill bit.

18. The method of claim 15, wherein attaching the cutting head to the end surface of the body of the drill bit includes brazing the cutting head to the end surface of the body of the drill bit.

19. The method of claim 15, wherein forming the cutting head includes forming the cutting head having a unitary body.

20. The method of claim 19, wherein the unitary body has a bottom surface that is oriented perpendicular to the axis, and wherein attaching the cutting head to the end surface of the body includes attaching the bottom surface of the cutting head to the end surface of the body.
